(19) United States
(12) Patent Application Publication
(10) Pub. No.: US 2011/0098045 A1
(43) Pub. Date: Apr. 28, 2011

(54) METHOD AND ARRANGEMENT IN A COMMUNICATION NETWORK SYSTEM

(76) Inventors: Johan Moe, Mantorp (SE); Pal Frenger, Linkoping (SE); Fredrik Gunnarsson, Linkoping (SE); Tomas Hedberg, Stockholm (SE)

(21) Appl. No.: 12/999,248

(22) PCT Filed: May 27, 2009
(86) PCT No.: PCT/SE2009/050606

§ 371 Date: Dec. 15, 2010

Related U.S. Application Data
(60) Provisional application No. 61/073,553, filed on Jun. 18, 2008.

(51) Int. Cl. H04W 60/00

(52) U.S. Cl. 455/435.1

(57) ABSTRACT

A method of signalling a set cell identities in a cellular radio system from a transmitter to a receiver is provided. The method includes coding of a sequence of cell identities using a range indicator. The coded sequence is then signalling using the coded sequence. The range indicator can be an range indicator or an explicit range indicator.

### FIELD OF THE INVENTION

The present invention relates to a method and arrangement in a communication network system, in particular to an arrangement allowing for efficient signalling of identities as well as a method for such signalling.

### BACKGROUND

The work of specifying the 3G Long Tetm Evolution (LTE) and System Architecture Evolution (SAE) concepts is currently ongoing within the 3rd Generation Partnership Project (3GPP). One important focus area in LTE/SAE standardization work is to ensure that the new network is simple to deploy and cost efficient to operate. The vision is that the new system shall be self optimizing and self configuring in as many aspects as possible. Several of the self-optimizing algorithms are based on signalling of identities.

One such aspect is simplification of planning, provisioning and operation of the radio environment. One example is to implement the Plug&Play concept, i.e. minimize the need for planning of radio resources.

Radio networks need to handle non-unique physical identifiers of base stations to support efficient measurement procedures, but also globally unique cell identities. In this context the following notation is made use of:
PLMN Identity: This is the identity of the Public Land Mobile Network. Note that a cell may have multiple PLMN identities.
Cell Identity: This is unique identifier for a cell within a PLMN.
Physical Cell Identity (PCI): This is a Layer 1 identifier for a cell. The PCI is an integer, not long enough to be unique within a Radio Access Network (RAN) (PCI).

In LTE the current assumption is to have 504 unique PCI. The terminals uses the reference symbols to measure the reference symbol received power (RSRP) and these measurements are used when performing initial cell selection as well as handovers. It is thus crucial that seen from each terminal there should always be a one-to-one mapping between the PCIs the terminal can detect and the cell identities. For Wideband Code Division Multiple Access (WCDMA) the PCI corresponds to the WCDMA “scramble code”. In WCDMA there are 512 different scrambling codes.

Handovers in LTE and WCDMA are mobile-assisted, which means that the terminal (or user equipment) reports measurements of serving cells and cell alternatives to the serving base station. The terminal may be configured to report all cells within parameterized range between the strongest cell and an offset that is parameterized in measurement control messages from the evolved NodeB (eNodeB), i.e. radio base station, to the terminal. The terminal shall not report measurements for cells that are black-listed. Similarly, the terminal shall only report measurement for cells that are included in a neighbour cell list.

One example of black-listing is when it is desirable to exclude home eNodeBs from a certain measurement configuration. A dedicated set or range of PCIs may be reserved for the home eNodeBs, and a macro eNodeB may exclude this set of PCIs from selected measurement configurations.

The network can store information relating to a neighbour set for each mobile terminal. The neighbour set is used for evaluation and handover of a mobile terminal from one cell to another as the mobile terminal crosses a cell boundary. It will be readily appreciated that the cell boundaries are not sharply defined, but will in practice be somewhat blurred as the range of the base stations will overlap with one another. Similarly, lists of identities are included in signalling between other nodes in the network. One example is the signalling of global cell identities to the mobile, in order to configure the home eNodeBs that the mobile is authorized to obtain services from.

The current means to signal a set of identities between nodes in a wireless network is as a sequence of cell identifiers. The cell identifiers belong to a limited alphabet, typically a range of integers, e.g. (0 . . . MaxIdentity-1) or (1 . . . MaxIdentity).

Assume that a limited alphabet of ordered elements has been defined to represent identities:
A={a1, a2, a3, a4, . . . , an}
   and that there are n different unique identities. Sets of identities can therefore be represented as a sequence of identities, e.g.
a1, a2, a3, a4, a5, a6, a7, a8, a9, a10, a12, a78
   Signalling a set of identities as a sequence of identities may give large messages. This is particularly so when the set of identities is a range of identities. There is a constant desire to improve the performance of signalling protocols. Hence there is a need for an improved method of signalling cell identifiers.

### SUMMARY

Thus, one object of the present invention is to provide an improved method and arrangement for efficiently signalling identities in a communication network system.

This object and others is obtained by the present invention as set out in the appended claims. Thus, by providing a range indicator into said sequence of identities an efficient signalling of a set of identities as a sequence of identities in a communication network system is provided.

The identity range encoding in accordance with the present invention enables an efficient encoding of sets of identities which at least in part consist of identity ranges. This means efficient signalling of some large identity sets.

Thus, in accordance with the present invention a method of signalling a set cell identities in a cellular radio system from a transmitter to a receiver is provided. The method includes coding of a sequence of cell identities using a range indicator. The coded sequence is then signalling using the coded sequence. The range indicator can be an implicit range indicator or an explicit range indicator.

When the signalled set of cell identities comprises a range of cell identities, the cell identity having the lowest number can in accordance with one embodiment be included in the signalled coded sequence.

The invention also extends to a device such as a radio base station or a mobile station comprising a transmitter configured to transmit cell identities in accordance with the above.

Other objects, advantages and novel features of the invention will become apparent from the following detailed description of the invention when considered in conjunction with the accompanying drawings and claims.

### BRIEF DESCRIPTION OF THE DRAWINGS

For a better understanding, reference is made to the following drawings and exemplary embodiments of the invention.

FIG. 1 shows an exemplary WCDMA communication network architecture;

FIG. 2 shows an exemplary LTE communication network architecture; and

FIG. 3 is a flowchart illustrating steps performed when signalling cell identities within a cellular radio network.

### DETAILED DESCRIPTION

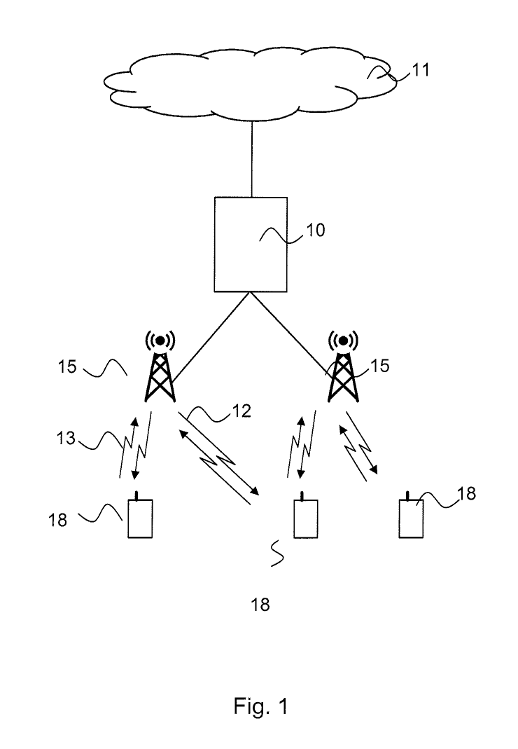

FIG. 1 depicts a communication network system including a Radio Access Network (RAN), such as the UMTS Terrestrial Radio Access Network (UTRAN) architecture, comprising at least one Radio Base Station (RBS) (Node B) 15 (two are shown in FIG. 1) connected to one or more Radio Network Controllers (RNCs) 10. The RAN is connected to a Core network (CN) 11. The RAN and the CN 11 provide communication and control for a plurality of user equipments (UE) 18 that each uses downlink (DL) channels 12 and uplink (UL) channels 13. For the reason of clarity, only one uplink channel is denoted 13 and one downlink channel denoted 12. On the downlink channel 12, the RBS 15 transmits to each user equipment 18 at respective power level. On the uplink channel 13, the user equipments 18 transmit data to the RBS 15 at respective power level.

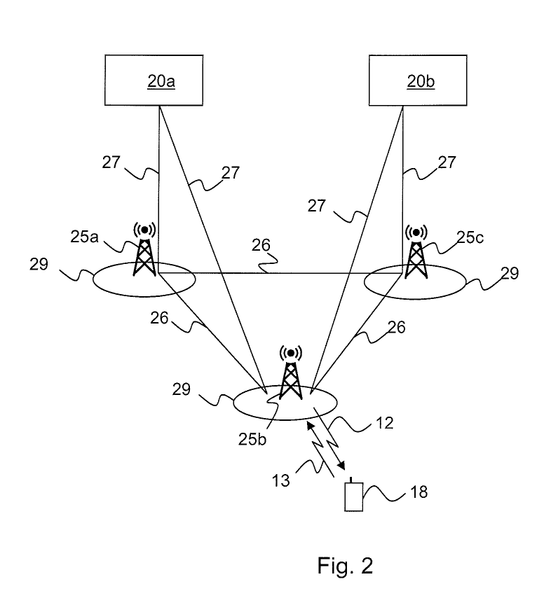

A communication system, such as a Long Term Evolution (LTE) system is shown in FIG. 2, including a Radio Access Network (RAN), comprising at least one Radio Base Station

(RBS) (or eNode B) 25a, 25b and 25c. The eNode Bs are connected over an interface such as the S1-interface 27 to at least one server gateway and mobility management entity node (S-GW/MME) 20a and 20b. The S-GW/MME node handles control signalling for instance for mobility, and is connected to external networks (not shown in FIG. 2) such as the Public Switched Telephone Network (PSTN) or the Integrated Services Digital Network (ISDN), and/or a connectionless external network as the Internet.

The RAN provides communication and control for a plurality of user equipments (UE) 18 (only one shown in FIG. 2) and each RBS 25a-25c is serving at least one cell 29 through and in which the UEs 18 are moving. The RBSs 25a-25c are communicating with each other over a communication interface 26, such as X2. The UEs each uses downlink (DL) channels 12 and uplink (UL) channels 13 to communicate with at least one RBS over a radio or air interface.

According to embodiments of the present invention, the communication network system is herein described as a WCDMA communication system or a LTE-communication system. The skilled person, however, realizes that the inventive method and arrangement works very well on other communications systems as well. The user equipments 18 may be mobile stations such as mobile telephones (“cellular” telephones) and laptops with mobile termination and thus may be, for example, portable, pocket, hand-held, computer-included or car-mounted mobile devices which communicate voice and/or data with the RAN.

According to one embodiment of the present invention the limited alphabet is extended with a range indicator. Thus in one exemplary embodiment, signalling of an identity list is performed by making use of one or more explicit or implicit range indicators. If the limited alphabet is a range of integers, then the range indicator may be the first integer preceding this range, or the first integer succeeding this range.

Below some examples are provided.

Consider the limited alphabet of ordered elements defined to represent identities:
A={a1, a2, a3, a4, . . . , an}
   and that there are n different representable identities. In this example the alphabet is extended to also include a range indicator ri:
Aext={a1, a2, a3, a4, . . . , an, ri}

### Alternative 1

When using the range indicator in a sequence of identities, it is interpreted as the range between the preceding identity and the succeeding identity. Sets of identities may therefore be represented as a combination of sequences of identities and ranges of identities, e.g.
a1, ri, a10, a12, a78
   is then interpreted as the set of identities
a1, −a10, a12, a78

In one exemplifying embodiment, consider the limited alphabet physical cell identities in LTE, which are the integers (1 . . . 504). Furthermore, the range indicator is encoded as the integer 0. When black listing home eNodeBs over the PCI range 1-10 in measurement control to the UE, then this may be encoded as the cell identity sequence
1,0,10

This is interpreted by the mobile station as:
1-10

In another exemplary embodiment, the range indicator is encoded as the integer 505.

In another exemplifying embodiment, ranges and sequences can be combined, e.g.
a1, ri, a10, a12, a17, a78, ri, a98, a109
   this is interpreted as the following set of identities:
a1-a10, a12, a17, a78-a98, a109

In another exemplary embodiment, the limited alphabet is the global cell identities in LTE.

In another embodiment, the signalling of the identity range is between two different network nodes.

In one embodiment, the signalling of the identity range is between a network node and the radio terminal.

In one embodiment, the signalling of the identity range is between a base station and the radio terminal.

### Alternative 2

When using the range indicator in a sequence of identities, it can be interpreted as a separator between unique identities and ranges. Sets of identities can therefore be represented as a combination of sequences of identities and ranges of identities, e.g.
a1, a12, ri, a22, a42, a78, a87
   is interpreted as the set of identities
a1, a12, a22-a42, a78-a87

This means that there can be an even or uneven amount of identities before the separator, but only an even amount of identities after the separator unless an open sequence is accepted. For example a78- can be accepted if the upper value is implicit from the alphabet.

### Alternative 3

Instead of using a separator an alternative is to use pairs of identities following a specific pattern, i.e. an implicit range indicator.
a) individual identities and sequences are always sent in a pair and
b) individual identities are sent in the opposite order compared with sequences

In this example we have defined the order to be ascending for individuals and descending for pairs.
(a1, a12), (a42, a22), (a87,a78) (a14,a14)
   is interpreted as the set of identities:
a1, a12, a14, a22-a42, a78-a87

With a1, a12 the first pair is filled but since there is only one more individual (a14) this embodiment requires padding another pair. This can be achieved in that the individual is repeated. Note that pairs may come in any order. The sequences can be signalled by having the upper limit, a42 and a87, first in the pair.

### Alternative 4

In this alternative, instead of using a separator, tuples can be used. For example the below schema can be used:
{ai, aj, ak, . . . , am, A}

Where A, the tuple interpreter, can be a binary coded defining a sequence or not. For example say that A is represented by 8 bits, then every tuple consists of 9 elements and A.

In one example
a1, a12, a14, a22-a42, a87-a78
   can be coded as (there are other alternatives):
{a1, a12, a14, a22,a42, a87,a78, a12, a12, 00010100=20}

A tuple is a sequence (also known as an “ordered list”) of values, called the components of the tuple. This alternative has a number of implications. More tuples would be needed if the data sent cannot be contained in one tuple. There is no difference between . . . , a22,a42 or a42,a22 since A defines if they together define a sequence or not. One can use 1 or 0 as to indicate a sequence. If the data to be sent cannot fill a tuple it can be padded with duplicates of sent elements as in the example. One must define the position for A in the tuple. Possible the representation of A is placed in the tuple to make the tuple dynamic in its size.

Thus, an exemplary procedure for efficiently signalling a set of identities as a sequence of identities in a communication network system comprises the step of providing a range indicator into said sequence of identities.

According to some embodiments, said range indicator is interpreted as a range between a preceding identity and a succeeding identity in said sequence of identities.

According to some embodiments, said range indicator is interpreted as a separator between identities and ranges, whereby said set of identities is represented as a combination of sequences of identities and ranges of identities.

According to some embodiments, said range indicator is to use pairs of identities following a pre-determined pattern.

According to some embodiments, said range indicator is one or more tuples.

An exemplary arrangement for efficiently signalling a set of identities as a sequence of identities in a communication network system comprises means for providing a range indicator into said sequence of identities.

According to some embodiments, said means for providing a range indicator is arranged to provide said range indicator as a range between a preceding identity and a succeeding identity in said sequence of identities.

According to some embodiments, said means for providing a range indicator is arranged to provide said range indicator as a separator between identities and ranges, whereby said set of identities is represented as a combination of sequences of identities and ranges of identities.

According to some embodiments, said means for providing a range indicator is arranged to provide said range indicator as pairs of identities following a pre-deteiiiiined pattern.

According to some embodiments, said means for providing a range indicator is arranged to provide said range indicator as one or more tuples.

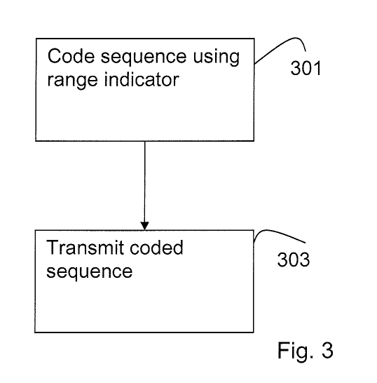

In FIG. 3 a flowchart illustrating some steps performed when signalling cell identities in a cellular radio system in accordance with the above is shown. First, in a step 301 coding of a sequence of cell identities using a range indicator is performed. Thereupon the coded the set of cell identities is transmitted to a receiver using the coded sequence.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

Expressions such as “including”, “comprising”, “incorporating”, “consisting of”, “have”, “is” used to describe the present invention are intended to be construed in a non-exclusive manner, namely allowing for items, components or elements not explicitly described also to be present. Reference to the singular is also to be construed to relate to the plural and vice versa.

1. A method of signalling a set of cell identities in a cellular radio system from a transmitter to a receiver, the method comprising:
coding a sequence of cell identities using a range indicator, and
signalling the set of cell identities using the coded sequence.

2. The method according to claim 1, wherein the range indicator is an implicit range indicator.

3. The method according to claim 1, wherein the range indicator is an explicit range indicator.

4. The method according to claim 1, wherein the signalled set of cell identities comprises a range of cell identities, and wherein one of the set of cell identities having a lowest number is included in the signalled coded sequence.

5. A transmitter for signalling a set of cell identities to a receiver in a cellular radio system, comprising:
a coding circuit configured to code a sequence of cell identities using a range indicator, and
a signalling circuit configured to signal the set of cell identities using the coded sequence.

6. The transmitter according to claim 5, wherein the range indicator is an implicit range indicator.

7. The transmitter according to claim 5, wherein the range indicator is an explicit range indicator.

8. The transmitter according to claim 5, further comprising:
wherein the coding circuit is configured to include one of the set of cell identities identity having a lowest number in the signalled coded sequence, when the signalled set of cell identities comprises a range of cell identities.

9. A radio base station comprising the transmitter according to claim 5.

10. The method according to claim 2, wherein the implicit range indicator comprises pairs of cell identities following a predetermined pattern.

11. The method according to claim 3, wherein the explicit range indicator is used to represent a range between a preceding cell identity and a succeeding cell identity in said sequence of cell identities.

12. The method according to claim 3, wherein the explicit range indicator is used as a separator between individual cell identities and ranges of cell identities, and wherein the set of cell identities comprises the individual cell identities and the ranges of cell identities.

13. The method according to claim 3, wherein the explicit range indicator comprises one or more tuples.
